(19) United States
(12) Patent Application Publication
(10) Pub. No.: US 2004/0087296 A1
(43) Pub. Date: May 6, 2004

(54) Radio receiver and method for AM suppression and DC-offset removal

(75) Inventors: Joonbae Park, Seoul (KR); Kyeongho Lee, Seoul (KR)

Correspondence Address: FLESHNER & KIM, LLP, P.O. BOX 221200, CHANTILLY, VA, 20153, US

(73) Assignee: GCT Semiconductor, Inc.

(21) Appl. No.: 10/689,932

(22) Filed: Oct. 22, 2003

Related U.S. Application Data
(60) Provisional application No. 60/421,053, filed on Oct. 25, 2002.

(51) Int. Cl. H04B 1/10

(52) U.S. Cl. 455/285; 455/283

(57) ABSTRACT

A communications receiver includes a baseband signal recovery circuit which uses a low-IF architecture for data reception. The baseband signal recovery circuit uses a full-analog implementation for channel selection and filtering. Thus, the overhead placed on the design of analog-to-digital converter is greatly relaxed and most of hardware can be re-used for multi-mode applications with only a slight modification.

### BACKGROUND OF THE INVENTION

This application claims the benefit of U.S. Provisional Application No. 60/421,053, filed Oct. 25, 2002. The entire disclosure of the prior application is considered as being part of the disclosure of the accompanying application and is hereby incorporated by reference herein.

1. Field of the Invention

This invention generally relates to signal-processing systems, and more particularly to a system and method for recovering a baseband signal in a receiver of a communications system

2. Background of the Related Art

The design of a radio transceiver having a small form factor and which can be manufactured at low cost is highly desirable for use in modern wireless communication systems, and this is especially true in cellular systems. However, a fully integrated radio transceiver design is difficult to implement because many cellular standards have severe performance demands in terms of sensitivity and selectivity.

The direct-conversion radio transceiver architecture is thought to be an ideal solution for replacing the widely-used superheterodyne architecture. The difficulty in design is much more severe in the receiver side than in the transmitter side because the selectivity and sensitivity requirements should be met at the same time in receiver.

FIG. 1 shows a related art superheterodyne radio receiver architecture, and FIG. 2 shows a related art direct-conversion radio receiver architecture.

One difference between these architectures is that the superheterodyne architecture performs channel selection and amplification at some specified IF(Intermediate Frequency). Even though one or more external channel selection filters are usually formed by ceramic filters or SAW filters, performing channel selection at IF is advantageous in at least the following respects.

First, DC-offset is not an issue because simple AC coupling can reject the generation of DC offset and enable fast settling. Also, a 1/f noise problem found in related art direct conversion radio receiver is minimized because the amplification is performed at an IF frequency which is far from DC. Second, strong blockers and adjacent channel signals are mostly filtered by almost-ideal passive filters. Thus, the concern for linearity is relaxed.

The direct-conversion radio receiver architecture should solve and address the aforementioned problems in the related art. Unlike the superheterodyne receiver, DC-offset is an issue in a direct conversion receiver and thus adequate DC-offset removal circuitry should be employed. Even though such DC-offset removal circuitry works, there are numerous drawbacks in real world applications.

First, the cut-off frequency of a DC-offset cancelling loop should be sufficiently smaller than the desired signal bandwidth to reduce the effect of inter-symbol interference. Normally, the cut-off frequency of the DC-offset cancelling loop is set to 1/1000 of channel bandwidth. Even though techniques have been proposed which can render this DC servo loop with a small die size, the design of circuit parameters may not be realistic, in the case of very small channel bandwidth like those used in GSM and PDC communication networks.

In the GSM standard, the channel spacing is 200 KHz and only 25 KHz in PDC. Even worse, the GMSK signal used in GSM standard has most of the signal energy at DC when down-converted to DC. Thus, DC-offset cancellation becomes harder to perform in GSM applications. The DC-offset cancellation loop can reject the static DC-offset, but a long transient is found when the dynamic DC-offset arises. The settling time is inversely proportional to the cut-off frequency and thus may not acceptable for some applications.

Especially, to satisfy all the requirements of GSM, the radio receiver should be designed to pass a single-tone blocking test and AM suppression test. Although the signal power is larger in case of single tone blocker, the built-in DC-offset removal circuit can easily filter out the DC-offset caused by the second-order distortion from the strong blocker signal, because the block signal is assumed to be continuous sine-wave signal. However, in the AM suppression test, the strong blocking signal arrives the middle of packet and thus the DC-offset caused by this blocker cannot be filtered out so fast and last for a long time for settling.

Also in GSM applications, one-time DC-offset cancellation is usually employed due to the packet-based signal transmission. In this case, the DC-offset will degrade the signal-to-noise ratio at the base-band output if it is not properly filtered at the digital base-band modem. Modern GMSK demodulators incorporate the high-performance analog-to-digital converter prior the digital signal processing. Although use of the analog-to-digital converter with high dynamic range and additional DC-offset correction method in DSP can solve this problem, it still puts the design difficulty for analog-to-digital converter and the DC-offset should not exceed the dynamic range of the analog-to-digital converter.

One method which has been proposed to solve the DC-offset problem and AM suppression is to use the analog-to-digital converter with high dynamic range and to adopt a DC-offset cancellation algorithm running in a digital signal processor. In this case, the amount of DC-offset should be small enough not to exceed the full dynamic range of the analog-to-digital converter. Typically, most of the channel selection and gain control is performed in a base-band modem, not in the analog part of the receiver. The design challenge lies in the design of a high-performance analog-to-digital converter.

Another method which has been proposed to solve the DC-offset problem or second-order distortion is to use a very low-IF architecture rather than a direct-conversion architecture. In a very low-IF architecture, the DC-offset caused by the second-order distortion lies outside the signal band and thus is easily removed by digital filtering. The requirement for IIP2 indicating the amount of the second-order distortion is relaxed by the amount of filtering in the low-IF receiver. However, digital filtering also requires a large number of bits in analog-to-digital converter and may not acceptable for its high-current consumption. Thus, use of digital low-IF radio receiver architecture is limited to applications such as GSM.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

The present invention is a receiver including a baseband signal recovery circuit which uses a low-IF architecture for data reception. The receiver preferably uses a full-analog implementation for channel selection and filtering. Thus, the overhead placed on the design of analog-to-digital converter is greatly relaxed and most of hardware can be re-used for multi-mode applications with only a slight modification. The present invention is suitable for use in applications requiring highly integrated radio receiver architectures.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram showing a related art superheterodyne radio receiver;

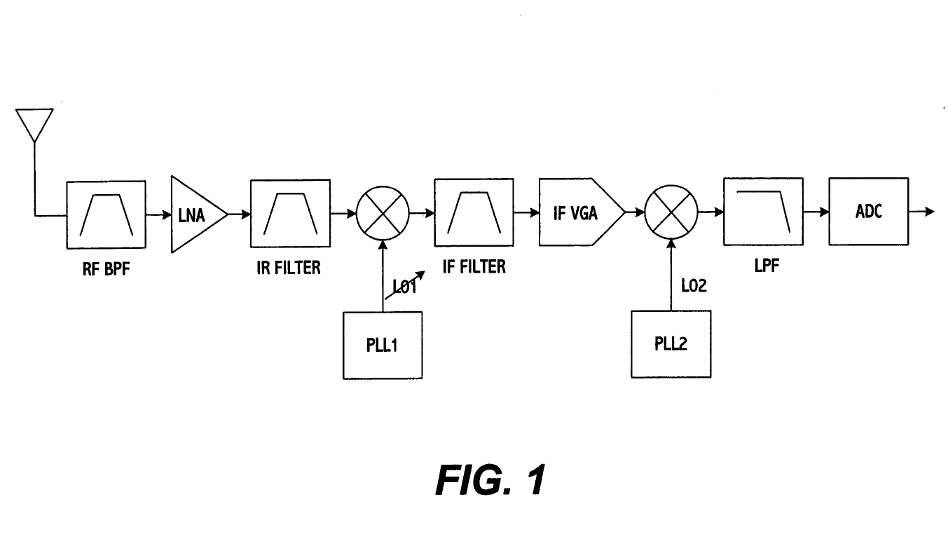

FIG. 2 is a block diagram showing a related art direct conversion radio receiver;

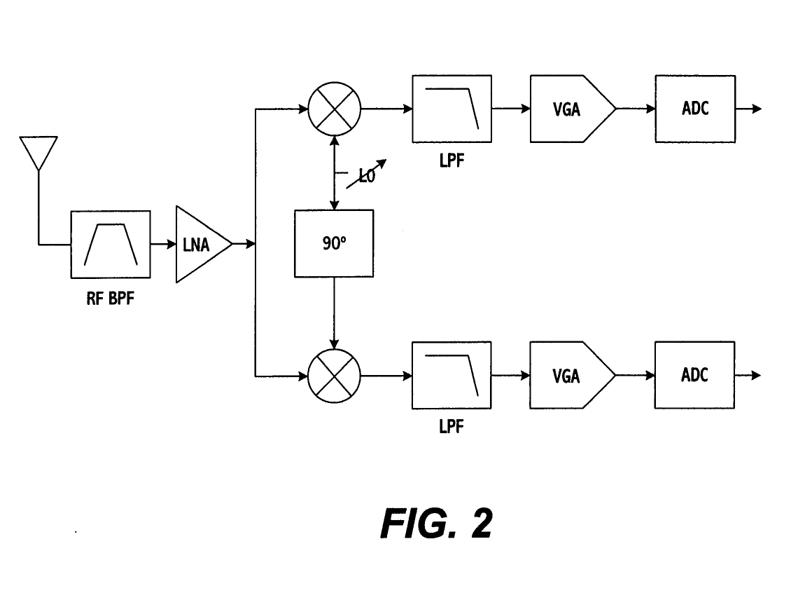

FIG. 3 is a block diagram of a radio receiver in accordance with an exemplary embodiment of the present invention;

FIG. 4 is a diagram showing a transfer function of an elliptic filter in accordance with an exemplary embodiment of the present invention;

FIG. 5 is a diagram showing waveforms produced at various stages of a radio receiver implemented in accordance with an exemplary embodiment of the present invention;

FIG. 6 is a block diagram showing a DDFS circuit for generating an oscillator signal which may correspond to the second local oscillator (LO) signal of the present invention; and

FIG. 7 is a block diagram showing another circuit for generating an oscillator signal which may correspond to the second local oscillator (LO) signal of the present invention.

### DETAILED DESCRIPTION OF PREFERRED EMBODIMENTS

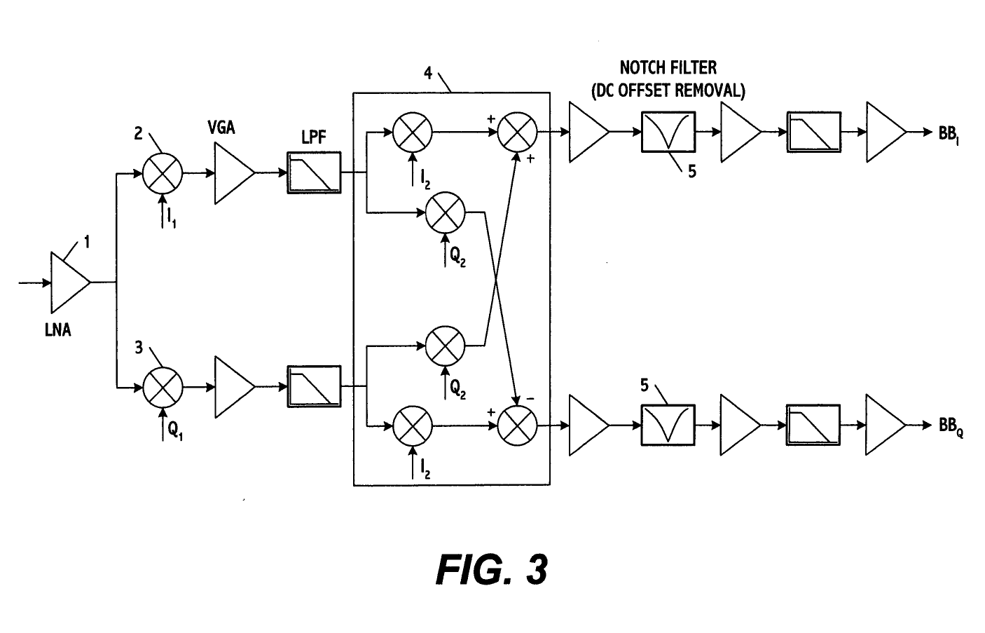

FIG. 3 shows a baseband signal recovery circuit in accordance with one exemplary embodiment of the present invention. Instead of the related art's direct-conversion radio architecture, the present invention uses a low-IF architecture for data reception. However, unlike other related art systems, at least one embodiment of the present invention uses a full-analog implementation for channel selection and filtering. Thus, the overhead placed on the design of analog-to-digital converter is greatly relaxed and most of hardware can be re-used for multi-mode applications with only a slight modification.

As shown in FIG. 3, an RF front-end mixer down-converts an RF signal from LNA 1 into respective intermediate frequency I and Q signals using a quadrature mixer, which includes mixers 2 and 3. The quadrature mixer should have well-matched phase and gain in I/Q signal for sufficient image rejection. By virtue of weak adjacent channel signal power in GSM standard, the required amount of image rejection will be around 40 dB.

After the first down-conversion stage, an optional gain stage and filtering stage may be employed to partially reject strong out-of-band signals and to block noise from propagating into the following stages.

The second down-conversion mixer 4 converts the low-IF signal into a baseband signal. After performing this second-down conversion, an optional gain stage may also be implemented to block noise from being input into the following stage. The residual DC-offset signal or induced dynamic DC-offset from the second-order distortion undergoes frequency translation via the second mixer, and the frequency becomes the same as the frequency of the second LO signal.

After the second-down conversion, a notch-filter 5 with a deep notch at the same frequency as that of the second LO signal is present to suppress this unwanted signal. Although a low-pass filter may be used to reject the unwanted signal, the notch filter is much more suitable for eliminating the single-tone signal caused by static or dynamic DC-offset. The notch filter may be implemented by an elliptic filter and/or a chebyschef-II type which has zero at some desired frequency. Unlike a DC servo loop, the response time of the present offset canceling circuitry is quite fast, because the DC-offset is translated into the high frequency rather than being located at DC. Thus, adverse effects from the DC-offset is greatly relaxed both in its absolute value and the correction time. The design of the second LO frequency is important in the present invention in terms of image rejection and capability of AM suppression. When the low IF architecture is used, some amount of signal leakage from the in-band blocking signal to the desired band is inevitable, due to the gain and phase imbalance in the first LO signal and first LO mixer (2 and 3 in FIG. 3).

For example, when the second LO signal is 100 KHz in a GSM application, the desired signal will be centered at 100 KHz. The in-band blocking signal located below 400 KHz from the desired signal will have some image component at 300 KHz. Since the in-band blocking signal at that frequency has the higher magnitude by more than 40 dB compared with the desired signal, the image rejection from the first mixer should be better than 36 dB to get the desired SNR. When the second LO signal moves toward higher frequency, the requirement in image rejection becomes much more severe because of higher blocking signal level. Thus, it is desirable to locate the second LO frequency as low as possible to relax the image requirement given to the first mixer. However, the transient response of the notch filter depends on the location of the notch, and the settling time is inversely proportional to the frequency. The DC offset caused by the strong blocking signal in a GSM application undergoes the frequency translation with the second mixer(4 in FIG. 3), becoming to the carrier leakage. This carrier leakage is proportional to the amount of the DC offset and the frequency is the same as the second LO signal. This carrier leakage should be removed quickly to avoid causing the bit error during the demodulation process in the base-band modem. Since the bit error happens in case that the transient time of the DC offset removal with the help of the notch filter is quite long, the location of the notch should be as high as possible. When considering both requirement of image rejection and transient response, the second LO frequency is usually determined close to 100 KHz.

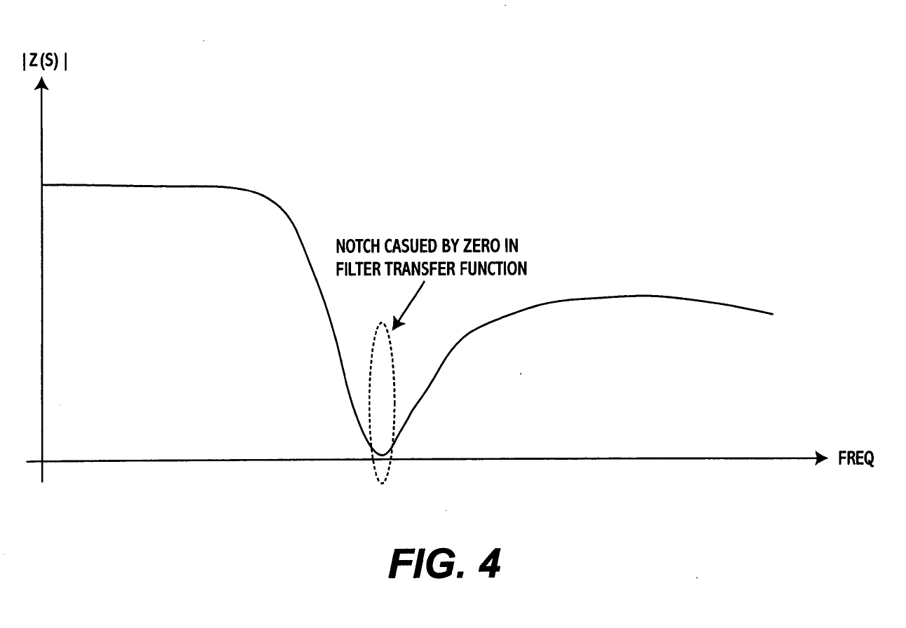

FIG. 4 is a diagram showing one example of a transfer function of an elliptic filter with a zero at a designed position. As shown in FIG. 4, the notch is caused by a zero in the filter transfer function. The zero in the filter transfer function means the gain at the particular signal frequency and thus can be suppressed sufficiently. When considering the particular example of a GSM receiver, the requirement for the second order-distortion is calculated as follows.

Consider the case where the input blocking signal has a power of −31 dBm at 6 MHz frequency offset from the desired signal and the desired signal has −99 dBm which is 3 dB above from the sensitivity level. To maintain 9 dB of SNR, the IIP2 at the input of LNA should be greater than

2×(−−)−(−99)+9=46 dBm (1)

Assuming the gain of the LNA to be 15 dB, the first down-conversion mixer should have IIP2 performance better than 61 dBm. This value is not readily achievable by other circuit design techniques that are used in the related art. However, in the two-step down conversion architecture of the claimed embodiments of the present invention, assuming that the notch filter suppresses the signal by 30 dB at the zero location, IIP2 performance can be relaxed by a same amount. The resulting requirement of IIP2 for the mixer is about 16 dBm, which is readily achievable.

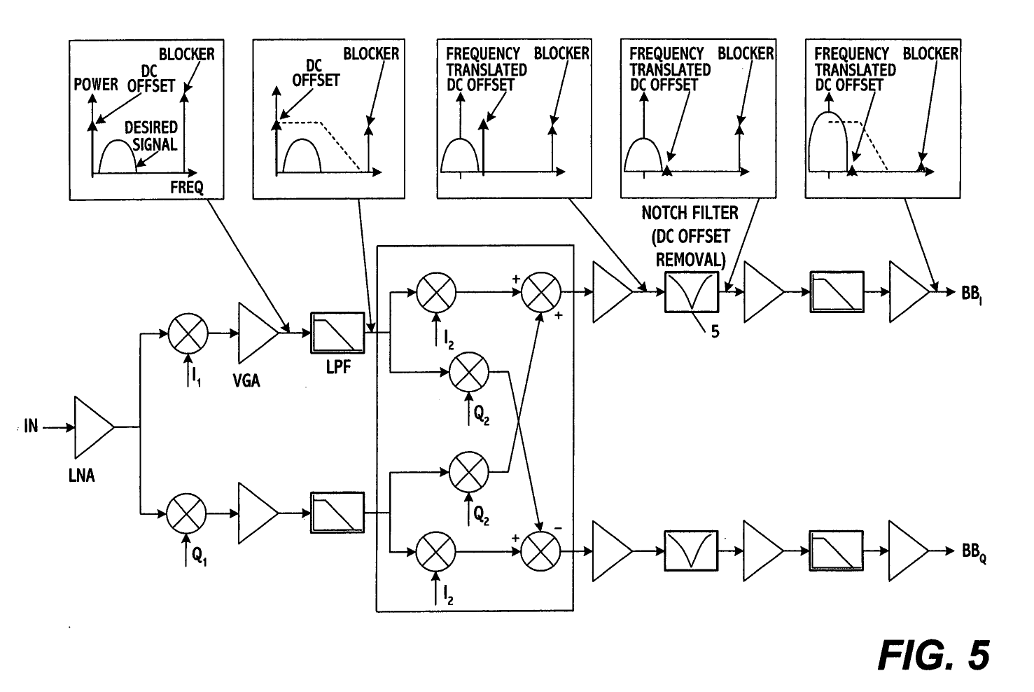

FIG. 5 shows various exemplary operating waveforms which may be produced at various stages of a receiver constructed in accordance with one exemplary embodiment of the present invention. As shown, when a strong blocking signal arrives at the input of LNA 1, some amount of DC-offset is produced especially in the first down-conversion mixer. Even though the low-pass filter after the first down-conversion mixer suppresses this blocking signal, DC-offset is produced due to second-order distortion. The IF signal is greater than the signal bandwidth and thus the DC-offset itself lies outside the desired signal.

After second-down conversion, the desired signal is centered at DC and DC-offset becomes a single-tone signal at the second LO frequency. The notch filter suppresses this single-tone signal to a negligible or acceptable level. Also, after the second down-conversion, the optional gain stages and filtering stages reject remaining interferers to provide the desired signal and meet the signal strength for the analog-to-digital converter.

In implementing the exemplary embodiments of the present invention, it is preferable for the second LO signal to be designed with a spectral purity in order to realize an acceptable signal-to-noise ratio (SNR). The harmonics of the second LO signal should be suppressed sufficiently, so as not to produce severe interference problems by harmonic mixing or spurious mixing. Also, it is preferable for the frequency of the LO signal to be exactly like the frequency of the first LO signal.

In accordance with one exemplary embodiment, the LO signals may be generated using a Phase Locked Loop (PLL) circuit. However, the frequency of the second LO signal may be too low in some circumstances, and when this condition does exist, it is quite ineffective to use a PLL for second LO generation.

Thus, in accordance with another exemplary embodiment, the present invention generates the second local oscillator (LO) frequency in one of two ways. The first way involves using Direct Digital Frequency Synthesizer (DDFS) for the generation of the second LO signal. One example of a DDFS technique suitable for use with the present invention is disclosed at the website www.analog.com.

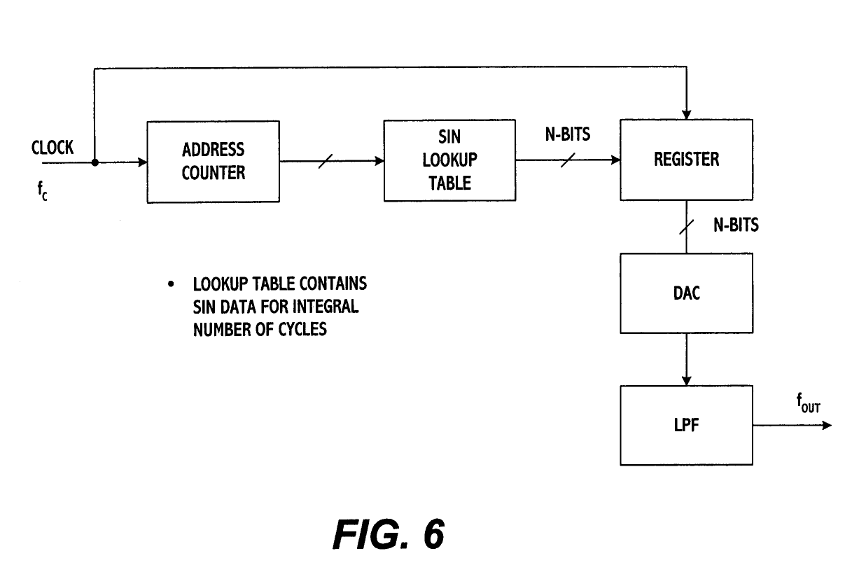

FIG. 6 shows a general block diagram of a circuit implementing a DDFS technique. In this diagram, the ROM table and DACs are clocked by the reference clock input, and the circuit generates a pure single-tone for the second LO signal. Depending on the size of ROM and bits of DAC, spectral purity in this example teaches less than −90 dBc. In FIG. 6, the sin lookup table contains sine data for an integral number of cycles. Those skilled in the art will appreciate that other transcendental function data can be used in the lookup table without departing from the spirit and scope of the present invention.

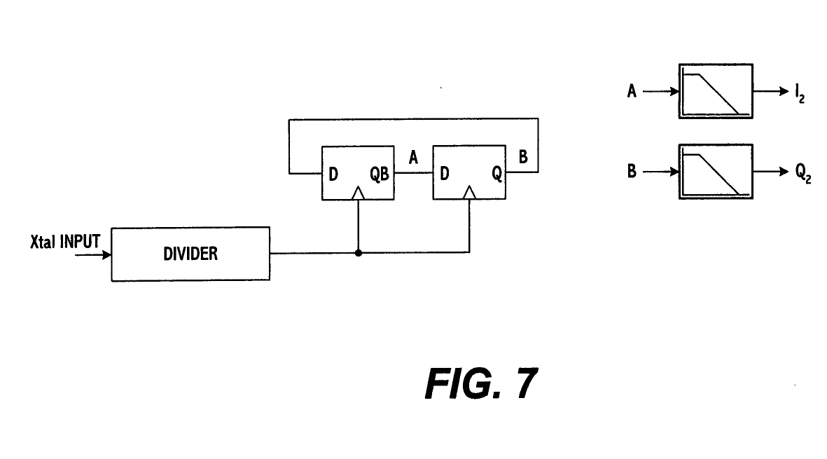

The second way involves using a divided reference clock input with post filtering to reject harmonic signals. FIG. 7 shows an exemplary circuit which generates an LO frequency signal based on this approach. When implemented in a GSM application, for example, the entire system uses 13 MHz or 26 MHz as the reference clock signal source from an external crystal oscillator. When divided by 100 or 200 times, the second LO signal becomes 130 KHz. The divide-by-4 circuit provides the exact quadrature signal for single-sided down conversion in the second mixer. The multiple harmonics of the clock signal is removed by additional filtering signal after the final dividing stage.

The present invention outperforms other related art systems in at least the following respects. The radio receiver architecture of the present invention uses an analog circuit technique to remove static DC-offset and dynamic DC-offset caused by strong blocking signal. By using an image-rejecting structure and a second mixer operating at very low frequency, the system requirement of IIP2 is greatly relaxed. Also, any DC-offset generated as a result of any kind of mismatch or sudden change in blocking signal level can be removed quite fast, because the DC-offset is translated into high frequency signal due to the frequency translation.

The transient response required to remove DC-offset is also fast, because a small time constant required in other related art DC-offset cancelling loops is no longer required. By using an analog implementation of the radio receiver which suppresses the DC-offset, the present radio receiver architecture can be applied to a fully integrated radio transceiver for most wireless applications including a GSM application.

In another exemplary embodiment of the present invention, a radio receiving method includes using a first front-end down-conversion mixer to down-convert an RF signal from a first low noise amplifier (LNA) into respective intermediate frequency I and Q signals.

In another exemplary embodiment of the present invention, a radio receiving method includes using a down-conversion operation to obtain a desired signal that is centered at DC and where a DC-offset becomes a single-tone signal at one of a plurality of local oscillator (LO) frequencies.

Other modifications and variations to the invention will be apparent to those skilled in the art from the foregoing disclosure. Thus, while only certain embodiments of the invention have been specifically described herein, it will be apparent that numerous modifications may be made thereto without departing from the spirit and scope of the invention.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A radio receiver comprising:
a first front-end down-conversion mixer that down-converts an RF signal from a first low noise amplifier (LNA) into respective intermediate frequency I and Q signals.

2. The radio receiver of claim 1, wherein a quadrature mixer performs a down-conversion of the RF signal and the mixer matches phase and gain in the I/Q signal.

3. The radio receiver of claim 2, wherein the phase and gain are matched to achieve an amount of image rejection.

4. The radio receiver of claim 1, wherein the amount of image rejection is about 40 dB.

5. The radio receiver of claim 1, wherein a gain stage and a filtering stage are used to partially reject out-of-band signals and to block noise from propagating into a following stage.

6. The radio receiver of claim 1, wherein a second down-conversion mixer converts a low-IF signal into a base-band signal.

7. The radio receiver of claim 6, wherein the second mixer translates a static or dynamic DC offset in frequency domain, resulting in a carrier leakage and the carrier leakage is located at the same frequency of the second LO frequency.

8. The radio receiver of claim 6, wherein a gain stage is used to block noise from being input into a following stage.

9. The radio receiver of claim 6, wherein a notch filter is used to eliminate a carrier leakage caused by static or dynamic DC-offset.

10. The radio receiver of claim 8, wherein the notch filter includes at least one of an elliptic filter and a chebyschef-II type filter.

11. The radio receiver of claim 1, wherein a plurality of local oscillator (LO) signals including at least a first LO signal and a second LO signal are generated using a phase locked loop (PLL) circuit.

12. The radio receiver of claim 10, wherein the second LO signal is generated using a direct digital frequency synthesizer (DDFS).

13. The radio receiver of claim 10, wherein the second LO signal is generated using a divided reference clock input with filtering to reject harmonic signals.

14. A radio receiving method comprising:
using a first front-end down-conversion mixer to down-convert an RF signal from a first low noise amplifier (LNA) into respective intermediate frequency I and Q signals.

15. The radio receiving method of claim 13, wherein a gain stage and a filtering stage are used to partially reject out-of-band signals and to block noise from propagating into a following stage.

16. The radio receiving method of claim 13, wherein a second down-conversion mixer converts a low-IF signal into a base-band signal.

17. The radio receiving method of claim 13, wherein a gain stage is used to block noise from being input into a following stage.

18. The radio receiving method of claim 13, wherein a low-IF architecture is used to receive data.

19. A radio receiving method comprising:
using a down-conversion operation to obtain a desired signal that is centered at DC and where a DC-offset becomes a carrier leakage signal at a second LO frequency.

20. The radio receiving method of claim 18, wherein a notch filter is used to suppress the carrier leakage to an acceptable level.

21. The radio receiving method of claim 18, wherein harmonics of a second LO signal are designed with a spectral purity to achieve an acceptable signal-to-noise ratio (SNR).

22. The radio receiving method of claim 21, wherein a frequency sum of a first LO signal and a second LO signal is the same as the desired RF signal frequency from the antenna.

23. The radio receiving method of claim 21, wherein a frequency of a first LO signal is the same as a frequency of a second LO signal.

24. The radio receiving method of claim 23, wherein the first LO signal is very high frequency close to the incoming carrier signal from the antenna and the second LO signal is close to DC and the overall receiver architecture becomes a low-IF architecture.
